(19) United States
(12) Patent Application Publication
(10) Pub. No.: US 2011/0153349 A1
(43) Pub. Date: Jun. 23, 2011

(54) HEALTH CARE DELIVERY MONITORING SYSTEMS AND METHODS

(75) Inventors: Daniel D. Anderson, Minneapolis, MN (US); Sherman L. Bartz, St. Paul, MN (US); Craig M. Carlson, Vadnais Heights, MN (US); Bernard A. Gonzalez, St. Paul, MN (US); Orlin B. Knudson, Vadnais Heights, MN (US); John M. Kruse, Minneapolis, MN (US); Craig D. Oster, Oakdale, MN (US)

(73) Assignee: 3M Innovative Properties Company

(21) Appl. No.: 12/905,214

(22) Filed: Oct. 15, 2010

Related U.S. Application Data
(60) Provisional application No. 61/251,955, filed on Oct. 15, 2009.

(51) Int. Cl. G06Q 50/00; G06Q 10/00

(52) U.S. Cl. 705/2

(57) ABSTRACT

Health care delivery monitoring systems and methods are described herein. The systems and methods may be used to monitor the delivery of health care bundles to one or more patients. The systems and methods may communicate with a health care worker delivering a health care bundle to provide selected information to the health care worker such as, e.g., one or more instructions regarding delivery of the health care bundle. In addition, the systems and methods described herein may further include the collection of compliance data to provide feedback regarding compliance with health care delivery protocols established within a health care facility.

### RELATED APPLICATIONS

The present application claims the benefit under 35 U.S.C. §119(e) of U.S. Provisional Patent Application No. 61/251,955, filed on Oct. 15, 2009 and titled HEALTH CARE DELIVERY MONITORING SYSTEMS AND METHODS, which is hereby incorporated by reference in its entirety.

### BACKGROUND

Systems and methods of monitoring health care delivery in the form of health care bundles are described herein

Healthcare Associated Infections (HAI) are a significant issue. Common HAIs include surgical site infections (SSIs), blood stream infections (BSIs), urinary tract infections (UTIs), ventilator associated pneumonia (VAP), and horizontally spread infections such as MRSA.

Improvement of health care outcomes can, in many instances, be influenced by the practices used to deliver care to patients. In the fast-paced, high stress environment encountered in many health care facilities, however, the uniform and effective delivery of health care can be compromised. Although some health care facilities may provide training and re-training to health care workers to improve the delivery of health care, such attempts are time-consuming, labor-intensive and, therefore, costly. Furthermore, the health care delivery practices are subject to continual changes as those practices are adapted in attempts to improve patient outcomes, thus necessitating further training and re-training.

### SUMMARY

Health care delivery monitoring systems and methods are described herein. In various embodiments, the systems and methods may be used to monitor the delivery of health care bundles to one or more patients. The systems and methods may, in some embodiments, involve communication with a health care worker delivering a health care bundle to provide selected information to the health care worker such as, e.g., one or more instructions regarding delivery of the health care bundle. The systems and methods described herein may, in some embodiments, include the collection of compliance data to provide feedback regarding compliance with health care delivery protocols established within a health care facility.

One potential advantage of some embodiments of the systems and methods described herein may include, for example, more uniform delivery of health care bundles to patients. Another potential advantage of some embodiments of the systems and methods described herein is the ability to obtain information regarding compliance with health care delivery protocols to provide feedback to the health care workers and/or others within the health care facility.

The systems and methods described herein may, in some embodiments, include one or more bundle credentials, one or more registration apparatus, one or more patient zone controllers, and one or more publication apparatus. As discussed herein, in some embodiments, the patient zone controllers preferably define a patient zone in which a patient may be located, the bundle credentials may be transported along with health care bundles in health care facility, the registration apparatus may be used to register delivery of the health care bundle to a patient, and the publication apparatus can be used to communicate with, e.g., a health care worker delivering a health care bundle to a patient. Some embodiments of the systems and methods described herein may include a compliance data collector used to collect data indicative of delivery of a health care bundle to a patient and whether or not such delivery is compliant with the protocols or requirements for acceptable delivery of the health care bundle.

The “health care bundles” described herein are used in the delivery of health care to patients, where a health care bundle may be defined as “a group of interventions (practices) related to a disease process that, when executed together, result in better outcomes than when implemented individually.” As used herein, a health care bundle will typically include one or more physical items, a process that involves use of the one or more physical items, and, optionally, monitoring of the process of using the one or more physical items. Monitoring of the process may include monitoring the time between performance of different steps within a specific health care bundle delivery sequence and/or the time between delivery of discrete health care bundles. Health care bundles may be used throughout patient care, i.e., in the pre-, peri-, and post-operative stages of health care.

The physical items of a health care bundle may include a kit (e.g., disposables such as catheters, alcohol wipes, drapes, hand cleaners, etc.), instruments (stethoscopes, environmental monitors, blood pressure monitors, etc.), or dispensers (hand sanitizer dispensers, sterile wipes, etc.). The processes included in health care bundles are steps used in the delivering of the health care associated with the bundle to a patient.

Health care bundles may be established for use with the delivery of almost any health care to a patient, including, but not limited to, e.g., urinary catheter care, intravenous catheter care, endotracheal tube care, instrument monitoring, delivery of medication, vital sign monitoring, environmental monitoring, etc.

As one example of a health care bundle, endotracheal tubes are used in combination with ventilators to assist patient respiration and may be the source of VAP (Ventilator Associated Pneumonia). A health care bundle for endotracheal tube care (sometimes referred to as a “VAP bundle”) may include physical items for providing oral care to the patient, as well as instructions regarding the processes to be implemented as part of the health care bundle (which may or may not actually involve use of the physical items in the health care bundle). Other health care bundles may be established for almost any other care to be provided to a patient.

The health care bundles and the delivery protocols associated with delivery of the health care bundles can vary between different health care facilities. Further, the health care bundles and the delivery protocols associated with delivery of any health care bundle within a given health care facility may change based on the patient (based on, e.g., the patient's age, condition, etc.), the health care worker delivering the health care bundle, changes in recommended practices, etc. In other words, the health care facilities may change the health care bundles and the delivery protocols based on any factor, i.e., improvement in patient outcomes, reducing costs without negatively affecting patient outcomes, etc.

In a first aspect, some embodiments of a system for monitoring health care delivery as described herein may include: a plurality of bundle credentials, wherein each bundle credential of the plurality of bundle credentials comprises bundle data associated with a selected health care bundle; registration apparatus configured to obtain the bundle data of the plurality of bundle credentials; a patient zone controller operably connected to the registration apparatus, wherein the patient zone controller is associated with only one selected patient and wherein the patient zone controller is configured to register the bundle data to the selected patient; and publication apparatus operably connected to the patient zone controller, the publication apparatus configured to communicate selected information to a person located proximate the selected patient, wherein the selected information is associated with the health care bundle that is registered to the selected patient.

In some embodiments of the systems described herein, a bundle credential of the plurality of bundle credentials comprises optical indicia that comprises the bundle data, and the registration apparatus comprises an optical reader configured to obtain the bundle data by reading the optical indicia and transfer the bundle data to the patient zone controller.

In some embodiments of the systems described herein, a bundle credential of the plurality of bundle credentials comprises on-board memory operably connected to a communication device, wherein at least some data transmitted and/or received by the communication device is stored by the on-board memory of the bundle credential, and wherein the on-board memory contains the bundle data associated with the selected health care bundle; wherein the patient zone controller defines a patient zone proximate the selected patient; and wherein the registration apparatus is configured to transfer the bundle data from the bundle credential to the patient zone controller when the bundle credential enters the patient zone.

In some embodiments of the systems described herein, a first bundle credential of the plurality of bundle credentials comprises optical indicia that comprises the bundle data and wherein a second bundle credential of the plurality of bundle credentials comprises on-board memory operably connected to a communication device, wherein at least some data transmitted and/or received by the communication device is stored by the on-board memory of the second bundle credential, and wherein the on-board memory contains the bundle data associated with the selected health care bundle; wherein the patient zone controller defines a patient zone proximate the selected patient; and wherein the registration apparatus is configured to transfer the bundle data from the second bundle credential to the patient zone controller when the second bundle credential enters the patient zone, and wherein the registration apparatus further comprises an optical reader configured to obtain the bundle data of the first bundle credential by reading the optical indicia and transfer the bundle data to the patient zone controller.

In some embodiments of the systems described herein, the system further comprises a bundle dispenser that comprises a carrier and a communication device, wherein the carrier comprises a plurality of health care bundles, and wherein the communication device is configured to receive and/or transmit bundle data associated with the plurality of health care bundles. In some embodiments, the bundle dispenser is associated with only one selected patient. In some embodiments, the bundle dispenser is configured to function as the bundle credentials for the plurality of health care bundles contained in the carrier. In some embodiments, one bundle credential of the plurality of bundle credentials is associated with each health care bundle of the plurality of health care bundles in the carrier.

In some embodiments of the systems described herein, the selected information published by the publication apparatus comprises at least one instruction for delivery of the health care bundle associated with the bundle credential.

In some embodiments of the systems described herein, the system further comprises a health care worker credential and data associating the health care worker credential with a selected health care worker. In some embodiments, a bundle credential of the plurality of bundle credentials comprises optical indicia that comprises the bundle data, and wherein the health care worker credential is operably connected to an optical reader configured to obtain the bundle data by reading the optical indicia and store the bundle data in on-board memory on the health care worker credential. In some embodiments, a bundle credential of the plurality of bundle credentials comprises on-board memory operably connected to a communication device, wherein at least some data transmitted and/or received by the communication device is stored by the on-board memory of the bundle credential, and wherein the on-board memory contains the bundle data associated with the selected health care bundle; and wherein the system is configured to transfer the bundle data from the bundle credential to the health care worker credential using the communication device of the bundle credential. In some embodiments, the patient zone controller is configured to define a patient zone proximate the selected patient, and further wherein the system is configured to transfer the bundle data from the health care worker credential to the patient zone controller when the health care worker credential enters the patient zone. In some embodiments, the publication apparatus is configured to transmit the selected information to the health care worker credential, and wherein the health care worker credential comprises a communication device configured to communicate the selected information to the selected health care worker.

In some embodiments of the systems described herein, the system further comprises a compliance data collector that is configured to collect compliance data that is indicative of delivery of the selected health care bundle. In some embodiments, the compliance data collector is operably connected to the patient zone controller. In some embodiments, the selected health care bundle comprises one or more components that comprise optical indicia, and wherein the compliance data collector comprises an optical reader configured to read the optical indicia on the one or more components.

In a second aspect, some embodiments of the systems for monitoring health care delivery as described herein may include: a plurality of bundle credentials, wherein each bundle credential of the plurality of bundle credentials comprises bundle data associated with a selected health care bundle; a health care worker credential that comprises: on-board memory operably connected to a communication device, wherein at least some data transmitted and/or received by the communication device is stored by the on-board memory; data associating the health care worker credential with a selected health care worker in the on-board memory; registration apparatus configured to obtain the bundle data of the plurality of bundle credentials and transfer the bundle data to the on-board memory; publication apparatus configured to communicate selected information to a person located proximate the health care worker credential; and a patient zone controller operably connected to the health care worker credential, wherein the patient zone controller is associated with only one selected patient and wherein the patient zone controller is configured to register bundle data received from the health care worker credential to the selected patient.

In some embodiments of the systems according to the second aspect, a bundle credential of the plurality of bundle credentials comprises optical indicia that comprises the bundle data, and wherein the registration apparatus comprises an optical reader configured to obtain the bundle data by reading the optical indicia.

In some embodiments of the systems according to the second aspect, a bundle credential of the plurality of bundle credentials comprises on-board memory operably connected to a communication device, wherein at least some data transmitted and/or received by the communication device is stored by the on-board memory of the bundle credential, and wherein the on-board memory contains the bundle data associated with the selected health care bundle; wherein the patient zone controller defines a patient zone proximate the selected patient; and wherein the health care worker credential is configured to transfer the bundle data to the patient zone controller when the health care worker credential enters the patient zone.

In some embodiments of the systems according to the second aspect, the selected information communicated by the publication apparatus comprises at least one instruction for delivery of the health care bundle associated with the bundle credential.

In some embodiments of the systems according to the second aspect, the publication apparatus comprises a visual display device and/or an audio device configured to communicate the selected information.

In a third aspect, methods of monitoring health care bundle use as described herein may include: associating a patient zone controller with only one selected patient; registering a selected health care bundle for delivery to the selected patient, wherein the registering comprises obtaining bundle data from a bundle credential associated with the selected health care bundle; publishing selected information to a health care worker delivering the registered health care bundle to a patient, wherein the selected information is chosen based on the registered health care bundle; and collecting compliance data that is indicative of delivery of the registered health care bundle to the patient.

In some embodiments of the methods described herein, the method further comprises determining if the health care worker is complying with a delivery protocol associated with the selected health care bundle, and delivering an alert to the health care worker if it is determined that the health care worker is not complying with the delivery protocol.

In some embodiments of the methods described herein, the registering comprises obtaining the bundle data associated with the selected health care bundle by scanning optical indicia on the bundle credential associated with the selected health care bundle.

In some embodiments of the methods described herein, the selected information comprises one or more instructions associated with delivery of the registered health care bundle.

In some embodiments of the methods described herein, collecting the compliance data comprises reading one or more optical indicia associated with the registered health care bundle.

In a fourth aspect, methods of monitoring health care bundle use as described herein may include: detecting entry of a bundle credential into a patient zone, wherein a selected patient is associated with the patient zone and wherein the bundle credential is associated with a selected health care bundle; registering the selected health care bundle associated with the bundle credential with the selected patient associated with the patient zone; and publishing selected information proximate the patient zone, wherein the selected information is selected based at least in part on the selected health care bundle.

In some embodiments of the methods described herein, the method comprises detecting entry of a health care worker credential into a patient zone, wherein a selected health care worker is associated with the health care worker credential.

In some embodiments of the methods described herein, the selected information comprises at least one instruction for using the selected health care bundle to provide health care for the selected patient.

In some embodiments of the methods described herein, the method further comprises collecting compliance data indicative of use of the registered health care bundle by the selected health care worker.

In some embodiments of the methods described herein, the registered health care bundle comprises a plurality of components, wherein one or more of the components comprises an optical indicia, and wherein collecting the compliance data comprises reading the optical indicia on the one or more components.

In some embodiments of the methods described herein, the method further comprises: comparing the registered health care bundle to a prescribed health care bundle for the selected patient associated with the patient zone; and providing an alert to the selected health care worker if the registered health care bundle is not prescribed.

In some embodiments of the methods described herein, the patient zone controller performs the entry detection of the health care worker credential, registers the health care bundle with the selected patient; and provides the selected information to the selected health care worker.

In some embodiments of the methods described herein, the patient zone controller performs the entry detection of the bundle credential.

In some embodiments of the methods described herein, entry detection of the bundle credential is performed by associating the bundle credential with the health care worker credential and detecting entry of the bundle credential upon detecting entry of the health care worker credential, wherein the bundle credential is associated with the health care worker credential before the health care worker credential is detected as entering the patient zone.

In some embodiments of the methods described herein, the method comprises comparing a selected or registered health care bundle to a prescribed health care bundle for the patient and providing an alert if the health care bundle is not prescribed.

In some embodiments of the methods described herein, determining if the health care worker is complying with a delivery protocol associated with a selected or registered health care bundle comprises detecting time between delivery of two different health care bundles.

In some embodiments of the methods described herein, determining if the health care worker is complying with a delivery protocol associated with a selected or registered health care bundle comprises comparing a sequence of detected events in the compliance data with a predetermined sequence of events in the delivery protocol.

In some embodiments of the methods described herein, determining if the health care worker is complying with a delivery protocol associated with a selected or registered health care bundle comprises comparing timing between detected events in the compliance data with a predetermined timing between events in the delivery protocol.

In some embodiments of the methods described herein, the method includes delivering an alert to the health care worker if it is determined that the health care worker is not complying with the delivery protocol comprises delivering one or more selective instructions for corrective action to the health care worker.

The words “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, a bundle credential may be used to refer to one, two, three or more bundle credentials.

The term “and/or” means one or all of the listed elements or a combination of any two or more of the listed elements.

The above summary is not intended to describe each embodiment or every implementation of the health care delivery monitoring systems and methods described herein. Rather, a more complete understanding of the health care delivery monitoring systems described herein will become apparent and appreciated by reference to the following Description of Illustrative Embodiments and claims in view of the accompanying figures of the drawing.

### BRIEF DESCRIPTION OF DRAWINGS

FIG. 1 is a block diagram of one illustrative embodiment of a health care delivery monitoring system as described herein.

FIG. 2 is a block diagram of a health care bundle dispenser that may be used in some embodiments of the systems and methods described herein.

FIG. 3 is a block diagram of another illustrative embodiment of a health care delivery monitoring system as described herein.

FIG. 4 is a block diagram of another illustrative embodiment of a health care delivery monitoring system as described herein.

FIG. 5 is a block diagram of one illustrative embodiment of a health care delivery monitoring system including multiple patient zone controllers, multiple health care worker credentials, and a central controller.

FIG. 6 depicts one illustrative method of monitoring health care bundle use as described herein.

FIG. 7 depicts another illustrative method of monitoring health care bundle use as described herein.

FIG. 8 is a diagram illustrating one embodiment of a dual mode communication system that may be used in some embodiments of the systems described herein.

### DESCRIPTION OF ILLUSTRATIVE EMBODIMENTS

In the following description of illustrative embodiments, reference is made to the accompanying figures of the drawing which form a part hereof, and in which are shown, by way of illustration, specific embodiments in which the systems and/or methods may be practiced. It is to be understood that other embodiments may be utilized and structural changes may be made without departing from the scope of the present invention.

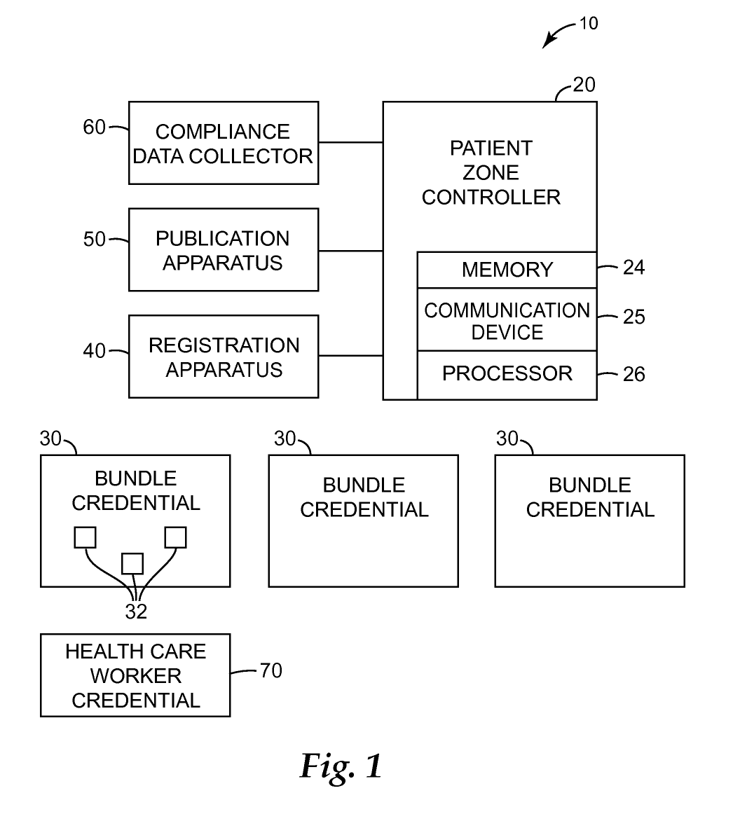

One illustrative embodiment of a system 10 for monitoring health care delivery is depicted in FIG. 1. The system 10 as depicted in FIG. 1 includes a patient zone controller 20, one or more bundle credentials 30, registration apparatus 40 operably connected to the patient zone controller 20, and publication apparatus 50 operably connected to the patient zone controller 20. The depicted system 10 may further include an optional compliance data collector 60 operably connected to the patient zone controller 20 and an optional health care worker credential 70.

Although the system 10 depicted in FIG. 1 includes specific numbers of the various components (e.g., three bundle credentials 30, one registration apparatus 40, etc.), the number of any of the components provided within any selected system may vary from as few as zero (for those components that may be optional), one (e.g., one registration apparatus 40), two, three or more. In other words, although only one registration apparatus 40 is depicted, it should be understood that some systems that include registration apparatus may include two or more different registration apparatus.

The various components of the system 10 may be configured to operate in manners as described herein to monitor health care delivery within any selected health care facility. As used herein, the term “health care facility” may include a variety of environments including, for example, hospitals, long-term care facilities, hospice facilities, health clinics, home health care environments, or any other patient-occupied setting.

The patient zone controller 20 of systems as described herein may preferably include, in various embodiments, an optional communication device 25 capable of transmitting and/or receiving data and optional on-board memory 24 that is operably connected to the communication device 25 to store received data and/or transmit stored data as a part of the operation of the system. The operable connection between the on-board memory and the communication device may typically be performed by an optional processor 26 that is also preferably resident on or in the patient zone controller. Examples of some potentially suitable processors may include, e.g., an Application Specific Integrated Circuit (ASIC) state machine, a gate array, a microprocessor, a microcontroller, etc. The processor in a patient zone controller may also, in some embodiments, be used to control operation of the patient zone and other functions of the patient zone controller as described herein.

The patient zone controllers used in systems and methods described herein may be provided in any format that is capable of providing the functions of a patient zone controller as described herein. In some embodiments, the patient zone controller 20 may be in the form of a mobile badge or other device that can be carried by or otherwise attached to the selected person (e.g., a patient) or piece of equipment in or on which the patient is located (e.g., a wheelchair, bed, etc.) in a health care facility in which the systems described herein are used. In some embodiments, the patient zone controllers 20 may be stationary devices positioned at fixed locations in a health care facility such that the patient zone controllers do not move with patients. In still other embodiments of systems and methods described herein, some of the patient zone controllers may be mobile devices while others may be stationary.

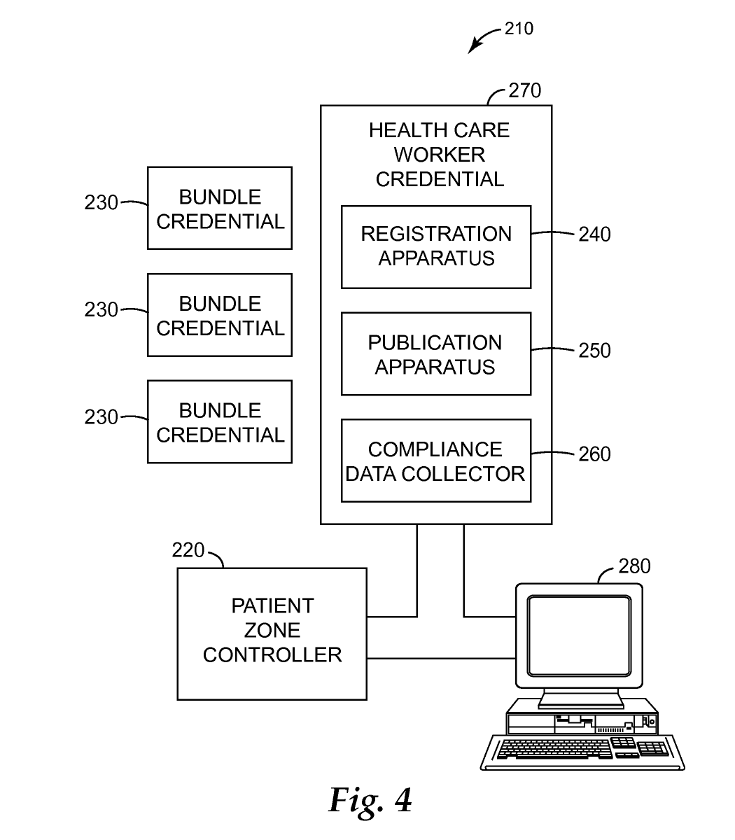

Each of the patient zone controllers as described herein may also preferably include data associating the patient zone controller with only one selected patient. In some embodiments, the data associating the patient zone controller with the selected patient may also or alternatively be located in the memory of a central controller that is operably connected to the patient zone controller 20 (see, e.g., the system described in connection with FIG. 4).

In some embodiments, the data associating the patient zone controller with a selected patient may be variable, i.e., may be changed as a part of the operation of the system by, for example, entering unique patient identification data into the system when the patient zone controller is assigned to the selected patient. In other embodiments, the data associating the patient zone controller with a selected patient may be fixed, i.e., the patient zone controller may itself contain unique identifying data that is assigned to the selected patient when the patient zone controller is issued or otherwise associated with the selected patient. In either case, the unique identifying data (whether unique to the patient or the patient zone controller) may, in some systems, be used to facilitate maintenance of the associated patient's Electronic Medical Record (EMR) as a part of the monitoring.

As depicted in FIG. 1, the system 10 includes one or more bundle credentials 30. Each of the bundle credentials 30 is preferably associated with a selected health care bundle. Typically, although not necessarily, each health care bundle will require the use of one or more items which may be disposable or reusable. In such a situation, the bundle credential may be provided on or in the item itself and/or in packaging used to deliver the one or more items of the health care bundle.

Each bundle credential 30 includes bundle data that is associated with the selected health care bundle that is associated with the bundle credential 30. In some embodiments, the bundle data may be limited, e.g., to identification of the selected health care bundle. In other embodiments, the bundle data present on or in the bundle credential may include information such as, e.g., one or more instructions for use or administration of the health care bundle, the delivery protocol associated with delivery of the health care bundle, etc.

Although the bundle credentials may take a variety of different forms, in the system 10 depicted in FIG. 1, the bundle credentials 30 may include, in some embodiments, a badge, tag, label, or any other article that can be carried by or otherwise attached to the one or more items that are included in the associated health care bundle. Regardless of the physical form of the bundle credentials 30, they include bundle data in one or more forms, with the bundle data being used to register the health care bundle associated with a bundle credential to a selected patient as described herein.

Potential forms of the bundle data may be optical indicia, volatile/nonvolatile memory (e.g., flash memory, etc.), alphanumeric characters, etc. The form or forms in which the bundle data is stored are preferably compatible with the registration apparatus 40 such that the registration apparatus can obtain the bundle data from the bundle credentials and transfer it to the patient zone controller 20 or another component in the system as described herein. Depending on the form in which the bundle data is provided, the registration apparatus 40 may include any combination of components configured to obtain the bundle data through one, two, or more different modes, e.g., wirelessly (using RF, ultrasonics), optically, keyboard, mouse, touch screen, touch pad, camera, microphone (used to, e.g., obtain voice feedback from a health care worker using voice recognition apparatus), etc.

In those embodiments that include bundle data in the form of optical indicia, the optical indicia may take a variety of different forms, e.g., a barcode, microdots, color coding, etc. In addition, the optical indicia provided as a part of the bundle credential 30 is preferably of a form that can be read by an optical reader that is provided as a part of the registration apparatus 40 of the system 10.

In other embodiments, one or more of the bundle credentials 30 may include a communication device capable of transmitting and/or receiving data and on-board memory that is operably connected to the communication device to store received data and/or transmit stored data as a part of the operation of the system. The operable connection between the on-board memory and the communication device may typically be performed by a controller that is also preferably resident on or in the health care worker credential. Examples of some potentially suitable controllers may include, e.g., an Application Specific Integrated Circuit (ASIC) state machine, a gate array, a microprocessor, a microcontroller, etc. One illustrative example of a combination of memory, communication device and processor may be in the form of a passive or active RFID tag.

In some embodiments, one or more of the health care bundles associated with a bundle credential 30 may include multiple sub-credentials 32 as depicted in connection with the left-most bundle credential 30 in FIG. 1. The sub-credentials 32 may be used to identify multiple items that may be provided as a part of a health care bundle (e.g., surgical gloves, bandages, disinfectant, etc.). As each item is used in delivery of the health care bundle the associated sub-credential can be scanned or otherwise registered (by, e.g., the registration apparatus 40) as one method of monitoring delivery of the health care bundle as described herein. In such a situation, the multiple sub-credentials 32 may be used to provide compliance data as a part of the compliance data collection associated with delivery of the health care bundles as described herein.

In some embodiments, the same technique used to obtain bundle data from the bundle credential 30 may be used to obtain data or otherwise register use of the items associated with the sub-credentials 32. In other embodiments, the techniques used to obtain bundle data from the bundle credential 30 may be different than that used to obtain data or otherwise register use of the items associated with the sub-credentials 32.

The illustrative embodiment of system 10 depicted in FIG. 1 includes, in addition to the bundle credentials 30 and registration apparatus 40, publication apparatus 50 that is preferably operably connected to the patient zone controller 20. The publication apparatus 50 may be configured in the system 10 to publish the selected information, where the publishing may include, e.g., visual and/or audible communication of the selected information such that a person located in or near the patient zone defined by the patient zone controller 20 can perceive the published information. In many cases, that person would be a health care worker who is there to administer the health care bundle to the patient.

The selected information published using the publication apparatus 50 may take a variety of forms, although it may preferably include at least one instruction for use of a health care bundle that is associated with bundle data that has been obtained by the patient zone controller 20. In the depicted system 10, the bundle data may preferably be obtained using a registration apparatus as described herein. Other selected information that may be communicated by the publication apparatus 50 may include, e.g., health care bundle identification information (to, e.g., allow a health care worker to verify that the health care bundle is to be used with the selected patient associated with the patient zone controller 20), etc.

The publication apparatus 50 may take a variety of different forms that are preferably capable of publishing information that can be perceived by a person. Examples of some potentially suitable devices that may be used as a part of the publication apparatus 50 may include a visual display device and/or an audio device.

Examples of some potentially suitable visual display devices may include, but are not limited to liquid crystal displays and other monitors adapted to display analog or digital images, printers, backlit displays designed for use with printed checklists, etc. An audio device (e.g., a speaker, etc.) used in connection with the publication apparatus 50 may be used to provide the selected information in an audible format.

As described above, the backlit display may include LED's or other light-emitting elements that can be used in connection with, e.g., a printed form that can be placed over the backlit display. In use, the printed form could be placed on the backlit display and selected portions of the printed form could be illuminated by the backlit display to provide the selected information to a health care worker (such as, e.g., which step in delivery of the health care bundle to perform next, etc.).

In some embodiments, the publication apparatus 50 may be dedicated for use with a selected patient zone controller 20. In other embodiments, the publication apparatus 50 may be provided in the form of a portable device, e.g., a PDA, cell phone, pager, wearable computer, etc. that is operably connected to the patient zone controller 20 either continuously, intermittently (e.g., when in proximity to the patient zone controller or otherwise identified as the appropriate publication apparatus for a selected health care bundle, etc.), etc. Such a portable publication apparatus 50 may be carried by a health care worker and used in connection with multiple patient zone controllers as the health care worker moves through a health care facility.

The selected information that is published or communicated using the publication apparatus 50 may be stored in one or more of a variety of locations in the system 10. In some embodiments, the selected information to be delivered by the publication apparatus 50 in connection with use of a health care bundle may be stored in the bundle credential 30 itself, in which case the registration apparatus 40 may preferably be operable to obtain the selected information from the bundle credential 30 and provide it to the publication apparatus 50 for communication to, e.g., a health care worker. In some embodiments, the selected information to be delivered by the publication apparatus 50 in connection with use of a health care bundle may be stored in the patient zone controller 20, in which case patient zone controller 20 is configured to provide the selected information (which may be stored in, e.g., a database within the patient zone controller 20) to the publication apparatus 50 for publication to, e.g., a health care worker. In some embodiments, the selected information to be delivered by the publication apparatus 50 in connection with use of a health care bundle may be stored in, e.g., a database in the publication apparatus 50 itself, in which case identification of the health care bundle results in selection and publication or communication of the appropriate selected information to, e.g., a health care worker. In some embodiments, the selected information may be stored in a central controller (as discussed, e.g., in connection with FIG. 4) and retrieved by or sent to the publication apparatus 50 based on the bundle data from the identified health care bundle. In still other embodiments, the selected information to be communicated may be stored in and/or retrieved from two or more locations.

The illustrated embodiment of system 10 depicted in FIG. 1 also includes an optional compliance data collector 60 that, in the depicted system is operably connected to the patient zone controller 20. The compliance data collector 60 is provided as a mechanism for collecting data that can be used to determine compliance with the protocols surrounding delivery of a health care bundle.

During use of the items or performance of the tasks associated with delivery of a health care bundle, compliance data may be provided to the compliance data collector that is indicative of the use of an item and/or performance of a task. That compliance data may be provided to the compliance data collector by the health care worker, by equipment associated with delivery of the health care bundle (e.g., the presence of a stream of data from an instrument such as a blood pressure monitor, etc. may indicate that the instrument has been activated), etc. With that compliance data, a system as described herein can be used to determine if all items and/or tasks associated with the delivery of a selected health care bundle have been used/performed and, from that data, make a determination as to compliance with the protocols associated with delivery of that health care bundle.

In some embodiments in which a health care bundle includes multiple items, each of which includes a separate sub-credential 32 (such as, e.g., optical indicia), those separate sub-credentials 32 can be scanned or otherwise registered with the compliance data collector 60 during delivery of the health care bundle. In some embodiments, the compliance data collector 60 may include components needed to register the sub-credentials 32. In other embodiments, the compliance data collector 60 may be operably connected to the registration apparatus 40 such that an optical reader or other data acquisition device of the registration apparatus 40 can be used to provide for such data entry into the compliance data collector 60.

In some embodiments, compliance data collection may involve the use of a checklist that is provided as a part of the health care bundle. The checklist may, for example, include optical indicia associated with the completion of separate tasks and the optical indicia can be scanned to provide compliance data regarding completion of the task as a part of delivering the health care bundle associated with the checklist.

The compliance data collector 60 can, for example, be configured to accept compliance data input by any suitable technique or combination of techniques, i.e., the data collection is not limited to the use of optical indicia. Examples of some other potentially suitable technologies that can be used to collect compliance data include, but are not limited to: a keyboard, mouse, touch screen, touchpad, microphone (used to, e.g., obtain voice feedback from a health care worker using voice recognition apparatus), camera, etc.

Although they are depicted as separate components in FIG. 1, in some embodiments one or more of the different components of the system 10 may be integrated into two or more devices that perform the functions of the combined components. For example, any two or more of the patient zone controller 20, the registration apparatus 40, the publication apparatus 50, and the compliance data collector 60 may be integrated into a common device. In other embodiments, for example, a patient zone controller 20 and a registration apparatus 40 may be integrated into a first device while the publication apparatus 50 and the compliance data collector 60 may be integrated into a separate second device.

The system 10 depicted in FIG. 1 also includes one or more optional health care worker credentials 70 (although only one health care worker credential 70 is depicted in FIG. 1). Each health care worker credential 70 used in the systems described herein may be associated with a selected health care worker in the health care facility in which the system 10 is used. As used herein, the term “health care worker” may refer to people who are professional caregivers (e.g., nurses, nursing assistants, physicians, physician assistants, etc.), other individuals may also be associated with a health care worker credential 70 if they are involved in the delivery of health care bundles as discussed herein (e.g., relatives, friends, etc. may take the status of a health care worker in, e.g., a home health care setting, hospice facility, etc.).

In a system such as system 10 in which registration apparatus 40 is used to register bundle credentials 30 (and their associated health care bundles) to a selected patient, the health care worker credential 70 may include data in a form that can be obtained by the registration apparatus 40 and transferred to the patient zone controller 20 (e.g., optical indicia that can be read by an optical reader provided in connection with the registration apparatus 40). Registering the health care worker credential 70 may allow the system to associate the selected health care worker with the delivery of the health care bundle registered to the selected patient. As a result, delivery protocol compliance data obtained as a part of delivery of a selected health care bundle by the compliance data collector 60 can be associated with selected health care workers. That association between health care bundles and health care workers can be used to, e.g., provide compliance information for the health care workers.

In some embodiments, the data associating the health care worker credential 70 with a selected health care worker may be variable, i.e., may be changed as a part of the operation of the system by, for example, entering unique identification data when the health care worker credential is assigned to the selected health care worker. In other embodiments, the data associating the health care worker credential with a selected health care worker may be fixed, i.e., the health care worker credential may itself contain unique identifying data that is assigned to the selected health care worker when the health care worker credential is issued or otherwise associated with the selected health care worker.

The data that assigns or associates a health care worker credential with a selected health care worker may be found in the patient zone controller 20, the health care worker credential 70 and/or any other component in the system. In a system that includes an optional central controller as described herein, the data indicative of assignment or association between a health care worker credential 70 and a selected health care worker may also or alternatively be found within the central controller in addition to or in place of the more local devices such as the patient zone controller 20 and/or the health care worker credential 70.

The health care worker credentials used in systems as described herein may take a wide variety of forms. In some embodiments, the health care worker credentials 70 may be provided in the form of a badge, tag, label, display device, PDA, cell phone, pager, or any other article that is carried by or otherwise attached to the selected health care worker as they move within a health care facility in which the systems described herein are used.

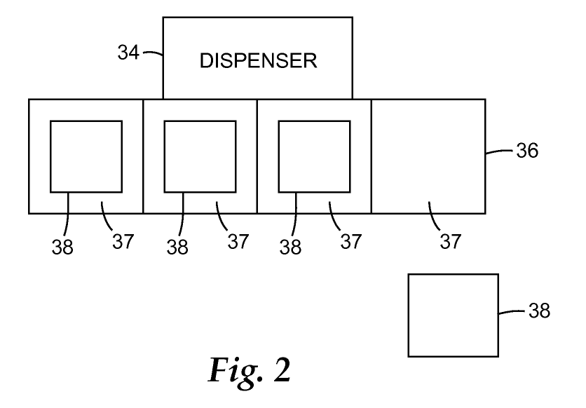

In some embodiments of the systems and methods described herein, a health care bundle dispenser may be used to dispense multiple health care bundles. One illustrative embodiment of a health care bundle dispenser 34 is depicted in FIG. 2.

The bundle dispensers 34 of systems as described herein may preferably include, in various embodiments, an optional communication device capable of transmitting and/or receiving data and optional on-board memory that is operably connected to the communication device to store received data and/or transmit stored data as a part of the operation of the system. The operable connection between the on-board memory and the communication device may typically be performed by an optional processor that is also preferably resident on or in the bundle dispenser 34. Examples of some potentially suitable processors may include, e.g., an Application Specific Integrated Circuit (ASIC) state machine, a gate array, a microprocessor, a microcontroller, etc. The processor in a bundle dispenser may also, in some embodiments, be used to control operation of the patient zone and other functions of the patient zone controller as described herein.

Each of the bundle dispensers as described herein may also, in some embodiments, include data associating the bundle dispenser 34 with only one selected patient. In some embodiments, the data associating the bundle dispenser with the selected patient may also or alternatively be located in the memory of a patient zone controller and/or a central controller that is operably connected to the bundle dispenser in the manner that the patient zone controllers and other components are connected as described herein.

In some embodiments, the data associating the bundle dispenser 34 with a selected patient may be variable, i.e., may be changed as a part of the operation of the system by, for example, entering unique patient identification data into the system when the bundle dispenser is assigned to the selected patient. In other embodiments, the data associating the bundle dispenser 34 with a selected patient may be fixed, i.e., the bundle dispenser may itself contain unique identifying data that is assigned to the selected patient when the bundle dispenser is issued or otherwise associated with the selected patient. In either case, the unique identifying data (whether unique to the patient or the patient zone controller) may, in some systems, be used to facilitate maintenance of the associated patient's Electronic Medical Record (EMR) as a part of the monitoring.

The depicted health care bundle dispenser 34 is associated with a carrier 36 that includes multiple bays 37 in which one or more health care bundles 38 may be located. In some embodiments, the carrier 36 may be integrated into the dispenser 34 and in other embodiments, the carrier 36 may be replaced by one or more different carriers that may be used to provide a replenished supply of health care bundles 38 for a selected bundle dispenser 34. If the carrier 36 is replaceable such that different carriers can be associated with the same bundle dispenser, then the bundle dispenser 34 may be configured to identify the carrier 36 and/or the health care bundles 38 loaded in the bays 37 of the carrier 36.

The bundle dispenser 34 may be operably connected to one or more other components in the systems described herein, e.g., a patient zone controller, a central controller, a registration apparatus, a health care worker credential, etc. by any of the communication techniques and equipment discussed herein. That connection between the bundle dispenser 34 and any of the other components may be used to communicate data regarding the dispensing of health care bundles 38 from the dispenser 34, data regarding the status of the bundle dispenser (e.g., the types and/or numbers of health care bundles 38 in the carrier 36 of the dispenser 34, etc.).

As health care bundles 38 are removed from the bays 37 of the carrier 36 associated with the bundle dispenser 34, the dispensing events may be reported to the system. For example, the bundle dispenser 34 may communicate dispense events to one or more other components in the systems described herein, e.g., a patient zone controller, a central controller, a registration apparatus, a health care worker credential, etc. The data communicated by the bundle dispenser 34 may also include bundle data for the health care bundle 38 dispensed (where that bundle data is similar to the bundle data as discussed herein).

Even in systems that include one or more bundle dispensers 34 as described herein, the health care bundles 38 dispensed from the bundle dispenser 34 may still include bundle credentials 30 as discussed herein. In some embodiments, however, the bundle dispenser 34 may act as a substitute for a bundle credential and operate within the system as discussed herein to provide the functions of a bundle credential for health care bundles 38 dispensed from the bundle dispenser 34 that do not, themselves, have a bundle credential.

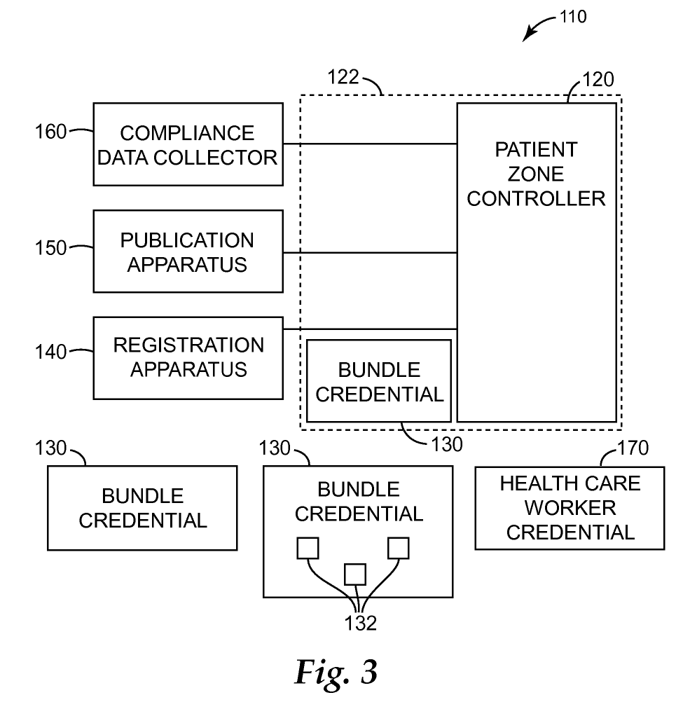

Referring again to FIG. 1, the system 10 as described herein and depicted in FIG. 1 uses optical indicia associated with the bundle credentials 30 to monitor delivery of health care bundles. Another illustrative embodiment of a system 110 for monitoring health care delivery is depicted in FIG. 3.

In the system 110 of FIG. 3, the patient zone controller 120 may include a communication device, on-board memory and a processor as described in connection with patient zone controller 20 of system 10 depicted in FIG. 1. The patient zone controller 120 or another component in a system containing the patient zone controller 120 may also preferably include data associating the patient zone controller with only one selected patient (as described in connection with patient zone controller 20).

The patient zone controller 120 depicted in connection with system 110 may be configured to define one or more patient zones 122, where each patient zone 122 defines one or more areas in which entry into the patient zone 122 by a bundle credential 130 and/or health care worker credential 170 can be detected.

By “define” as used in connection with the patient zones defined by the patient zone controllers described herein, it is meant that a patient zone controller preferably includes the components (e.g., hardware, processors, software, sensors, transducers, etc.) required to establish, form, emit, etc. the patient zones described herein. While the patient zone controller may, in some embodiments, be provided as a one-piece integrated unit contained within a single housing, in other embodiments, the patient zone controller may take the form of two or more components such as a main housing and operably connected emitters, sensors, etc. as required to define the patient zone(s) for the particular patient zone controller, where at least one of the components is not contained within the main housing.

The patient zones defined by the patient zone controllers of the systems described herein may, in some embodiments, be large enough to contain a patient such that physical contact with the patient is typically not possible without entry into the patient zone 122, although in some instances the size of the patient zone may be reduced such that the patient is not entirely contained within the patient zone 122. Also, it should be understood that although components of the system 110 may be depicted as outside of the patient zone 122 (e.g., registration apparatus 140, publication apparatus 150, compliance data collector 160, etc.), those components may be located inside or outside of the patient zone 122 in any system 110 using a patient zone 122.

In some embodiments, the boundaries of the patient zones defined by the patient zone controllers may be somewhat variable depending on the technology used to define the patient zone, i.e., the boundaries of the patient zone may not necessarily be as distinct as the line depicted the zone boundary in FIG. 3. Examples of some potentially suitable technologies that may be incorporated into the patient zone controller to define the one or more patient zones such that entry into the patient zone may be detected may include, for example, RF (Radio Frequency) reflection, acoustic reflection (using, e.g., ultrasonic energy, etc.), RFID (Radio Frequency Identification) detection, LIDAR (Light Detection and Ranging), RTLS (Real Time Location System), infrared detection and/or imaging, optical imaging, capacitive detection, pressure sensing mats/materials, etc.

RF reflection is a technique in which a Radio Frequency (RF) signal is emitted from an emitter. Bundle credentials and/or health care worker credentials entering a patient zone are detected if they reflect the RF signal back to a detector. Acoustic reflection detection is performed by emitting acoustic energy (e.g., ultrasonic energy) and detecting the acoustic energy that is reflected by a zone entrant. RFID detection is performed by transmitting an initiating RF signal within the patient zone and detecting a predetermined return RF signal emitted by an RFID tag (associated with, e.g., a bundle or health care worker credential) that receives the initiating RF signal because it is located within the patient zone. Optical techniques for zone entry detection may include, e.g., disruption of a light beam and LIDAR (which is another reflection technique relying on an emitter and detector combination)—in some embodiments, LIDAR can also be used for detection through optical imaging. Optical image processing can be used to capture images, with the images used for zone detection. Pressure mats typically detect the presence of an individual (e.g., nurse, doctor, etc.) stepping on the mat and/or the presence of a piece of equipment (e.g., an IV stand, blood pressure monitor, etc.) located on the pressure mat. The zone detection techniques described herein are not meant to be exhaustive; virtually any technology that can be used to detect entry into and/or exit from a zone can be used in connection with the systems and methods described herein.

The system 110 depicted in FIG. 3 includes a plurality of bundle credentials 130 that are associated with health care bundles and include bundle data as discussed above in connection with the bundle credentials 30 of system 10. Each of the bundle credentials 130 may, however, include features that provide for detection of the bundle credentials 130 located within the patient zone 122 by the patient zone controller 120.

As the bundle credentials 130 enter the patient zone 122 defined by the patient zone controller 120, the registration apparatus 140 operably connected to the patient zone controller 120 may automatically obtain the bundle data that is stored on the bundle credentials 130 by any suitable communication link established between the bundle credential 130 and the registration apparatus 140. It may be preferred that the registration apparatus 140 and the patient zone controller 120 be configured such that only those bundle credentials 130 detected as entering the patient zone 122 are registered to the patient associated with the patient zone controller 120 by the registration apparatus 140. As a result, for example, registration of health care bundles can be limited in facilities that include multiple patients in the same room.

Although the bundle credentials may take a variety of different forms, in the system 110 depicted in FIG. 3, one or more of the bundle credentials 130 may include components that are configured to transfer their bundle data to the registration apparatus 140 upon entry of the bundle credential 130 in the patient zone 122. For example, the bundle credentials 130 may include a communication device capable of transmitting and/or receiving data and on-board memory that is operably connected to the communication device to store received data and/or transmit stored data as a part of the operation of the system. The operable connection between the on-board memory and the communication device may typically be performed by a controller that is also preferably resident on or in the bundle credential 130. Examples of some potentially suitable controllers may include, e.g., an Application Specific Integrated Circuit (ASIC) state machine, a gate array, a microprocessor, a microcontroller, etc. One example of a combination of memory, communication device and processor may be in the form of a passive or active RFID tag.

Although one or more of the bundle credentials 130 may contain an RFID tag or other component such that the bundle data can be automatically obtained by the registration apparatus 140, one or more of the bundle credentials may also include bundle data in another form such as, e.g., optical indicia as described in connection with the bundle credentials 30 of system 10. In such a system, the registration apparatus 140 may include components configured to obtain bundle data through two or more different modes, e.g., wirelessly (using RF, ultrasonics), optically, keyboard, mouse, touch screen, touch pad, microphone, camera, etc.), etc.

One of the bundle credentials 130 depicted as a part of system 110 includes multiple sub-credentials 132 that may be used to identify multiple items that may be provided as a part of a health care bundle (e.g., surgical gloves, bandages, disinfectant, etc.) as discussed above in connection with the system 10 of FIG. 1.

The system 110 depicted in FIG. 3 includes a publication apparatus 150 similar to the publication apparatus 50 of system 10, an optional compliance data collector 160 similar to the compliance data collector 60 of system 10 and an optional health care worker 170. These components preferably perform substantially the same functions in system 110 as their counterparts in system 10 as depicted in FIG. 1.

Although they are depicted as separate components in FIG. 3, in some embodiments two or more of the different components of the system 110 may be integrated into a single device that performs the functions of the combined components. For example, any two or more of the patient zone controller 120, the registration apparatus 140, the publication apparatus 150, and the compliance data collector 160 may be integrated into a common device.

FIG. 4 depicts another illustrative embodiment of a system 210 that may be based on the use of a health care worker credential 270 that itself may include one or more of the other system components described in connection with the systems of FIGS. 1-3.

The depicted health care worker credential 270 optionally includes registration apparatus 240 that is configured to obtain bundle data from the bundle credentials 230 by any suitable technique or combination techniques and transfer that data so that the health care bundle can be registered to a selected patient as discussed herein. For example, if the bundle data of the bundle credentials 230 is contained in optical indicia, the registration apparatus 240 may include or be in the form of an optical reader. If the bundle data of the bundle credentials 230 is contained in, e.g., an RFID tag, the registration apparatus 240 may include or be operably connected to the appropriate components (e.g., memory, communication device, processor, etc.) required to obtain that bundle data. In some embodiments, the registration apparatus 240 may include components required to obtain bundle data from bundle credentials 230 by two or more different techniques (e.g., the registration apparatus 240 may include both an optical scanner for use with optical indicia and a communication device for use with RFID tags, etc.).

The depicted health care worker credential 270 also optionally includes publication apparatus 250 that may be used to publish or communicate selected information regarding selected health care bundles associated with the various bundle credentials 230 to the health care worker associated with the credential 270. As such, the health care worker credential 270 may include a display, device, audio device, etc. as needed to convey the selected information to the health care worker.

In some embodiments, the health care worker credential 270 may also optionally include a compliance data collector 260 as described herein that is configured to collect data that can be used to determine compliance with the protocols surrounding delivery of a health care bundle. During use of the items or performance of the tasks associated with delivery of a health care bundle, the health care worker may provide input to the compliance data collector 260 that is indicative of the use of an item and/or performance of a task. With that data, a system as described herein can be used to determine if all items and/or tasks associated with the delivery of a selected health care bundle have been used/performed and, from that data, make a determination as to compliance with the protocols associated with delivery of that health care bundle.

The compliance data collector 260 can be configured to accept data input by any suitable technique or combination of techniques, i.e., the data collection is not limited to the use of optical indicia. Examples of some other potentially suitable technologies that can be used to collect compliance data include, but are not limited to a keyboard, mouse, touch screen, touchpad, microphone (used to, e.g., obtain voice feedback from a health care worker using, e.g., voice recognition apparatus), camera, etc.

The health care worker credential 270 is depicted as operably connected to both a patient zone controller 220 and a central controller 280. It should be understood that both of these operable connections are optional, i.e., the health care worker credential 270 may be operably connected to either the patient zone controller 220 and/or the central controller 280. Communication between the different components may be relatively continuous or intermittent (e.g., after completion of a health care bundle delivery process, when entering and/or exiting a patient zone, at the end of a work shift or a portion of a work shift, etc.). In some systems, the connection between the health care worker credential 270 and a patient zone controller 220 may be limited to the times when the health care worker credential 270 is detected within a patient zone defined by the patient zone controller 220 as described herein.

Another optional connection depicted in FIG. 4 is a communication link between the patient zone controller 220 and the central controller 280. In some embodiments of the systems described herein, the patient zone controller 220 may be connected to a larger system that includes the central controller 280.

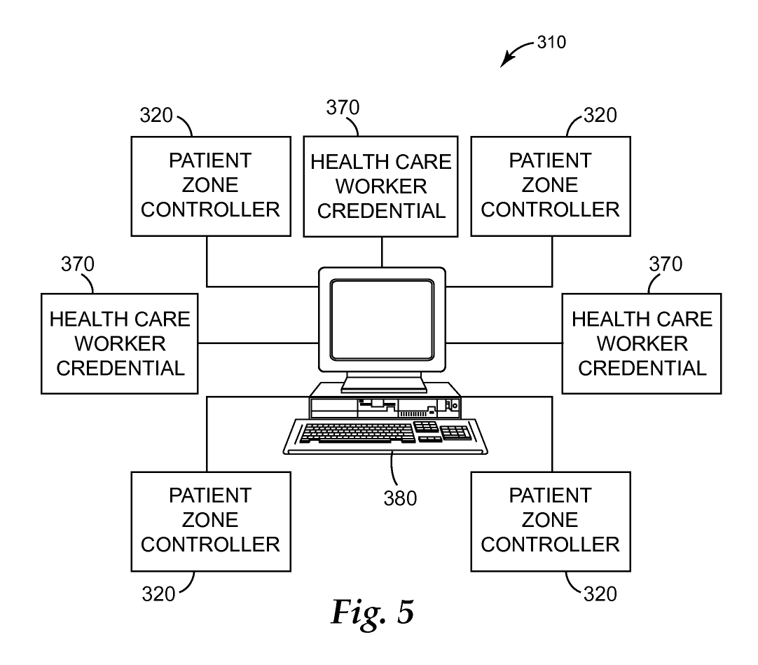

One illustrative embodiment of a larger system 310 is depicted in connection with FIG. 5 which includes a central controller 380, multiple patient zone controllers 320, and multiple health care worker credentials 370 that are operably connected to the central controller 380.

Although a specific number of the different components are depicted in connection with the system 310 of FIG. 5, the systems described herein may include any suitable number of the various components. For example, although the system 310 includes four patient zone controllers 320, a system as described herein may be implemented with as few as one patient zone controller 20 (as depicted in, e.g., FIGS. 1, 3, and 4) or any other number of patient zone controllers. Further, the number of health care worker credentials 370 provided within a system may vary from as few as one health care worker credential (as depicted in, e.g., FIG. 1) to any other number of health care worker credentials (including zero health care worker credentials in some systems). Similarly, although a single central controller 380 is depicted in connection with system 310, the central controller 380 may actually be embodied in a distributed manner such that multiple sub-central control units are networked together to provide a central controller function to the system 310.

The optional central controller 380 may include, e.g., one or more data processing units capable of executing software and associated central memory, with the data processing unit(s) and software operating to store and/or retrieve data on central memory associated with the central controller 380. The central controller 380 may also preferably include a communication device capable of transmitting and/or receiving data from one or more other components within the system 310 that can be stored on the central memory of the central controller 380.

The optional central controller 380 may be operably connected with a variety of different components in the system 310. In the embodiment depicted in FIG. 5, the central controller 380 is depicted as operably connected to the patient zone controllers 320 and the health care worker credentials 370. In such a system, the central controller 380 may be capable of at least receiving data from the patient zone controllers 320 and/or health care worker credentials 370 and may also be capable of transmitting data to the patient zone controllers 380 and/or health care worker credentials 370.

In some systems, the central controller 380 may also communicate directly with other components that may be included in the system, but that are not represented in FIG. 5. For example, the central controller 380 may communicate with components such as, e.g., optical readers or other registration apparatus, publication apparatus, compliance data collectors, etc. either directly or through a patient zone controller or health care worker credential.

In other embodiments, however, the systems described herein may not require such comprehensive communication schemes between a central controller 380 and the other components in the system. For example, it may be sufficient in some systems if the central controller 380 is in communication with, e.g., the patient zone controllers 320. In such a system, compliance information, i.e., use of health care bundles and compliance data obtained as a part of the monitoring of health care delivery, can be shared with the central controller 380 through communication links between the central controller 380 and the patient zone controllers 320.

With respect to the central controller 380, the communication links between the central controller 380 and any other system components to which the central controller 380 is operably connected may be “real-time” such that data is communicated as it is obtained (and as can be reasonably accommodated on the communication links being used). In other systems, data (such as compliance data) may be communicated within the system in a batch mode where data may be accumulated in one or more components before being delivered to the central controller 380. For example, the health care bundle use and/or compliance data stored on a patient zone controller 320, health care worker credential 370, and/or any other system component may be communicated to the central controller 380 at selected intervals such as, e.g., minutes, hours, days, number of events, etc. Still further, some systems may use a combination of both real-time and batch mode data transfer between the various system components.

Furthermore, as discussed herein, the system 310 may include a variety of different communication links with the various components in the system. In some embodiments, the communication links between the different components may be the same or different. For example, the communication links between the central controller 380 and the health care worker credentials 370 may be different than the communication links between the central controller 380 and the patient zone controllers 320 (e.g., the central controller 380 may communicate with the health care worker credentials 370 through a wireless connection while the central controller 380 may communicate with the patient zone controllers 380 through a hardware link, etc.).

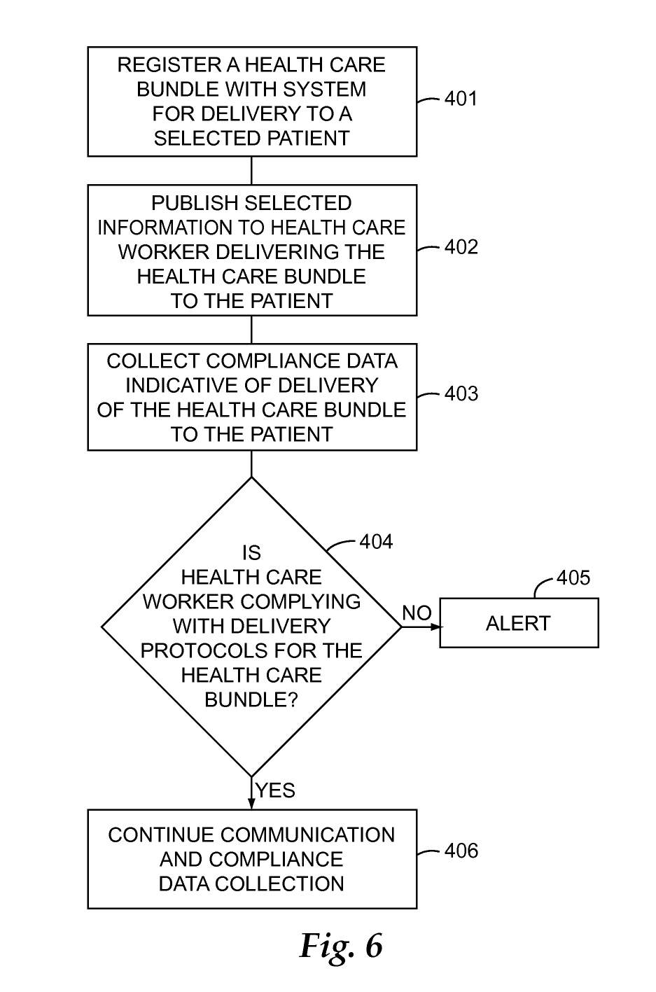

The systems and methods described herein may be used to monitor use of health care bundles and compliance with the protocols established for the health care bundles. Referring to FIG. 6, the depicted method may include registering a health care bundle with the system for delivery to a selected patient (401). Registration of the health care bundle may be performed by any suitable technique, some of which may include scanning optical indicia associated with the health care bundle, obtaining data by wireless communication between the bundle credential of a health care bundle upon entry of the bundle credential into a patient zone as described herein, manual input of data, associating the health care bundle with a health care worker credential which enters the patient zone, etc. In some embodiments, registration of a health care bundle may be reported to other systems within a health care facility. For example, health care bundle registration may be reported to an inventory management system (to assist with inventory control), to a billing system (for billing to the selected patient), and/or to the patient's Electronic Medical Record (EMR).

After registration of the health care bundle, the method may include publishing selected information to a health care worker or other person delivering the health care bundle to the patient (402). In the context of a system that includes a patient zone as described herein, the publishing may be described as delivering the selected information in one or more formats (e.g., visual, audible, tactile, etc.) such that a person located in or near the patient zone can perceive the published information. As discussed herein, the selected information may include one or more instructions for use of the physical items and/or the performance of tasks associated with delivery of the health care bundle in a manner that is in compliance with the accepted protocols for delivery of the health care bundle. The selected information delivered to the health care worker as a part of the communication may be different based on any of a number of factors as discussed below in connection with the selection of delivery protocols. The differences may include differences in the content of the information as well as the manner or mode in which it is delivered (i.e., visual, audible, tactile, etc.).

The method as depicted in FIG. 6 further includes the optional step of collecting compliance data that is indicative of delivery of the health care bundle to the patient (403). The compliance data may be collected by any number of a variety of different techniques that may include, but are not limited to, scanning optical indicia, using data input devices (such as touch screens, touch pads, keyboards, mice, etc.), microphones that may be connected to voice recognition systems, detecting data streams from instruments that may be used in connection with delivery of the health care bundle (e.g., detecting a stream of blood pressure data from a blood pressure monitor, etc.), detecting the status of equipment associated with compliant delivery of the health care bundle (e.g., determining the degree of incline on a bed, etc.), cameras (that may be associated with imaging apparatus), and others In some embodiments, items associated with a health care bundle may be scanned by an optical scanner as they are used by the health care worker during delivery of the health care bundle.

The compliance data collected can then be used by the system to make a determination as to whether or not the health care worker is complying with the delivery protocols for the health care bundle being delivered (404). If that determination is affirmative, i.e., that the health care worker is complying with the delivery protocols for the health care bundle, then the delivery process may continue with the communication and compliance data collection (406).

If, however, it is determined that the health care worker is not complying with the delivery protocol for the health care bundle being delivered to the patient, then the method may involve the delivery of an alert (405). That alert may be delivered to one or more locations, e.g., the alert may be delivered to the health care worker to allow the health care worker to take corrective actions during the delivery process. In some embodiments, the alert may be delivered along with one or more selective instructions to assist the health care worker in taking the remedial actions required to correct the breach in the delivery protocol.

Compliance with the delivery protocols associated with a health care bundle as discussed herein may involve a determination as to whether a task or process has been performed. Although some embodiments of systems could use imaging (still, video, etc.) to monitor compliance for tasks/processes, the systems and methods may, instead, use proxies for the tasks/processes. For example, if the delivery protocol for a health care bundle includes a hand hygiene requirement (i.e., that the health care worker sanitize his or her hands as a part of the process), compliance with the hygiene process may be indicated by the dispensing a hand sanitizing solution. As another example, use of a specific item in a kit supplied as a part of a health care bundle (e.g., a sanitizing wipe used to sanitize a portion of a patient's skin) may be indicated if, e.g., a package containing the wipe is scanned or otherwise registered with the system. In both of the instances described above, the actual process is not detected, but a proxy associated with the process is detected. Many other proxies, which are too numerous to list, may be used in connection with delivery protocol compliance monitoring as discussed herein.

Compliance with a health care bundle delivery protocol may involve more than merely determining that all of the physical items associated with the health care bundle are used and/or that all of the process steps (or their proxies) have been indicated as having been performed. In some embodiments, health care bundle delivery protocol compliance may be determined based on the time between delivery of two different health care bundles. In other words, if a selected health care bundle should, according to the delivery protocol established for that health care bundle, be delivered at selected time intervals, then compliance may require that the time interval between discrete health care bundles be detected and used to determine delivery protocol compliance. For example, if the delivery protocol for a type of health care bundle (e.g., a VAP bundle) includes a requirement that the health care bundle be delivered to a patient every four hours, then the delivery protocol compliance may be based on a determination of the time between bundles. That is, if the time between delivery of two health care bundles exceeds the selected interval (e.g., four hours—with perhaps some discretionary time window), then a determination that a non-compliant health care bundle delivery event has occurred may be made.

Another optional factor in determining health care bundle delivery protocol compliance may involve the sequence of detected events within a given health care bundle. In other words, if the delivery protocol for a health care bundle requires the use of physical items and/or performance of tasks in a particular sequence, then detection of use and/or performance that varies from the specified particular sequence may result in a determination that a non-compliant health care bundle delivery has occurred.

Still another factor in determining health care bundle delivery protocol compliance may involve the timing between detected events within a given health care bundle. In other words, if the delivery protocol for a health care bundle requires the use of physical items and/or performance of tasks that are determined to take a selected amount of time to perform, then detection of use and/or performance of the steps at time intervals that are too short and/or too long may result in a determination that a non-compliant health care bundle delivery has occurred. For example, if it is determined that a skin cleansing step requires at least a period of twenty seconds for acceptable performance, then a detection of the following or subsequent step within delivery of the health care bundle may result in a determination that a non-compliant event has occurred within the delivery of that health care bundle.

The alerts delivered in response to non-compliant delivery may be tiered. In other words, the alerts may be issued to the health care worker delivering the health care bundle such that the health care worker may take corrective actions at the point-of-care. As another tier, an alert may be delivered, in some instances, to supervisory personnel (e.g., to the nursing station, etc.). As yet another tier, alerts may be delivered to health care facility quality assurance and/or management personnel. The higher tier alerts may be based on accumulated compliance data, i.e., if the compliance percentages in a section of the health care facility begin to fall, the alert to supervisory, management, and/or quality personnel can provide an opportunity for corrective action on a broader basis.

In addition, the alerts can be dynamic, i.e., if compliance for a selected health care worker, group of health care workers, etc. begins to decline, some embodiments of the systems and methods described herein may provide a different set of alerts that may, for example, be more urgent, noticeable, etc. Such dynamic alerts may also be configured for delivery to a wider group, e.g., supervisory, quality, and/or management personnel within the health care facility.

The alerts may be provided using any suitable component(s) of the systems described herein, e.g., patient zone controller, publication apparatus, health care worker credential, etc. The alert may take any suitable form, e.g., visible, audible, tactile, etc. Examples of some alerts may be found in, e.g., US Patent Application Publication 2008/0246599 (Hufton et al.); U.S. Pat. No. 6,975,231 (Lane et al.); U.S. Pat. No. 6,882,278 (Winings et al.); U.S. Pat. No. 6,727,818 (Wildman et al.); U.S. Pat. No. 6,426,701 (Levy et al.); U.S. Pat. No. 5,952,924 (Evans et al.); U.S. Pat. No. 5,202,666 (Knippscheer); U.S. Pat. No. 4,896,144 (Bogstad); etc. In still other embodiments, alerts and/or feedback may be provided using devices that are not a part of the system, i.e., one or more devices other than those specifically described herein.

Compliance data that is collected by the systems and methods described herein may be used locally (as discussed herein) to provide time-of-care feedback to the health care worker delivering the health care bundle. The compliance data may also be reported to supervisory or management personnel, accumulated over time for trend analyses, etc.

In some systems, the data collected with respect to health care bundle delivery may be provided directly to a health care provider, insurance company, patient, and/or the patient's EMR (Electronic Medical Record), with the data including the types of care received and/or the compliance with delivery protocols established for the delivered health care bundles. That data may be delivered to the patient electronically (e.g., using electronic mail), on a data storage device (e.g., memory card), in a printed report, or any other suitable technique.

Selection of the delivery protocols to be applied in connection with any selected health care bundle may be based on a variety of one or more different factors. The factors used may be associated with the selected patient to which the health care bundle is to be delivered. Examples of some potentially useful patient-based criteria may include, for example, the health of the patient, the type of illness or condition from which the patient suffers, etc. Selection of health care bundle delivery protocols may also or alternatively be based on what may be considered “environmental” factors that are not necessarily associated with the selected patient such as, e.g., the type of health care facility in which the patient is located, the time of day, day of the week, time of year, outbreaks of contagious illnesses in the health care facility itself and/or in the community in which the health care facility is located, etc.

In still other variations, the health care bundle delivery protocols applied for delivery of a selected health care bundle may be based on still other factors such as, e.g., the historical protocol compliance rate for the health care bundle. For example, health care facilities (or portions of those facilities (e.g., wards, departments, etc.)) that have a historically low delivery protocol compliance rate for a selected health care bundle may be subject to a different set of communications, rules, alerts, reminders, etc. that are designed to improve the compliance rate over time. In some instances, the selection of a particular delivery protocol for a selected health care bundle and/or patient may be based on the historical compliance rate for a particular health care worker (or a particular group of health care workers). For example, home health care workers may be subjected to a set of delivery protocols, communications, alerts, reminders, etc. that are different than those applied to other health care workers.

The selection of delivery protocols to be applied for delivery of a selected health care bundle may be accomplished within, e.g., a patient zone controller or any other component in the system. In some embodiments, the protocol selection may be accomplished locally, i.e., at the patient zone controller, registration apparatus, publication apparatus, health care worker credential, etc. using any suitable technique, e.g., keypad, touch screens, switches, buttons, knobs, voice commands, etc. In other embodiments, the selection process may be performed using an external device such as a dedicated programming device, PDA, cell phone, etc. In still other embodiments, the delivery protocol(s) selected and applied for delivery of the health care bundle may be variable based on, e.g., the health care worker delivering the health care bundle (with the selection thus typically occurring automatically within the system). In some embodiments in which an optional central controller is present, the delivery protocol selection may be accomplished by communication between the central controller and the appropriate component(s) in the system, e.g., the central controller may drive the selection of the delivery protocol(s) to be applied in connection with a health care bundle based on any of a number of factors (such as those described herein).

As discussed herein, the selection of the delivery protocols to be applied for the delivery of selected health care bundles may be based on a wide variety of factors. In some embodiments of the systems and methods described herein, the delivery protocols associated with delivery of health care bundles may be changed or modified within the system for any of a number of reasons. For example, a given health care facility may modify the delivery protocol associated with a selected health care bundle to take into account changes in accepted practices, changes in the health care worker skill level, changes in perceived risk, etc. Fundamentally, the delivery protocols may be modified for any purpose by the health care facility based on any factors that are deemed significant enough to require delivery protocol modification.

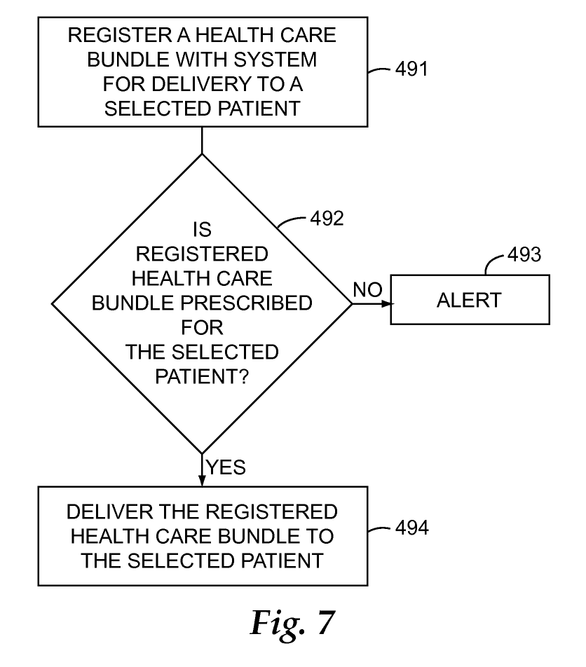

Referring to FIG. 7, the methods and systems described herein may also be used to reduce the likelihood that a health care bundle will be mis-delivered, i.e., that a health care bundle will be delivered to a patient in the absence of any need for delivery of the health care bundle to the patient.

As depicted in FIG. 7, the method may include registering a health care bundle with the system for delivery to a selected patient (491). Registration of the health care bundle may be performed by any suitable technique, some of which may include scanning optical indicia associated with the health care bundle, obtaining data by wireless communication between the bundle credential of a health care bundle upon entry of the bundle credential into a patient zone as described herein, manual input of data, associating the health care bundle with a health care worker credential which enters the patient zone, etc.

After registration of the health care bundle, the method may include determining whether or not the registered health care bundle is prescribed for the selected patient (492). As used herein, the term “prescribed” is used in a broad sense, meaning that health care workers other than physicians or physician assistants can “prescribe” or otherwise indicate that a selected patient should receive a health care bundle.

If it is determined that the registered health care bundle has been prescribed for the selected patient, delivery of the health care bundle to the patient can continue (494) as described, for example, in connection with the method depicted in FIG. 7.

If, however, it is determined that the registered health care bundle has not been prescribed for the selected patient, then an alert can be generated to notify the health care worker and/or others that the registered health care bundle should not be delivered to the patient. The alert may take any suitable form, some of which are described above in connection with the alerts issued in the method of FIG. 7.

Although not explicitly discussed herein, the systems and methods of monitoring the delivery of health care bundles may include monitoring the hygiene of both health care workers and equipment within a health care facility. In some embodiments, the systems and/or methods described herein may be integrated with an existing hygiene monitoring system to assist with monitoring all aspects of the delivery of health care bundles as described herein.

In particular, the systems and/or methods of monitoring health care bundle delivery as described herein may be integrated with the systems and/or methods of monitoring hygiene of both people and equipment as described in U.S. Provisional Patent Application No. 61/245,936, filed Sep. 25, 2009, titled PATIENT-CENTRIC HYGIENE MONITORING SYSTEMS AND METHODS; U.S. Provisional Patent Application No. 61/299,216, filed on Jan. 28, 2010, titled HYGIENE MONITORING SYSTEMS AND METHODS; and U.S. patent application Ser. No. 12/889,503, filed on Sep. 24, 2010, titled HYGIENE MONITORING SYSTEMS AND METHODS.

As described herein, the various components in the systems described herein may communicate information to each other using any suitable technology or combinations of two or more technologies. In some embodiments, the different components may communicate with each other wirelessly using any suitable wireless communication mode such as RF signals (e.g., RFID-based systems, etc.), acoustic energy (e.g., ultrasonic energy, etc.), optical energy (e.g., infrared, etc.). In other embodiments, the communication links may be wired links using cables (e.g., USB, Firewire, optical cables, etc.).

Further, the various components may provide data to each other either passively and/or actively. Typically, however, at least one of the components in any pair of communicating components includes active communication technology in the form of a device capable of receiving data from at least one other component. For example, a patient zone controller may include an optical reader (one example of an active communication device) while the bundle credential associated with a health care bundle includes data in the form of optically readable indicia (e.g., a barcode, microdots, color coding, etc.). As a result, communication between the patient zone controller and the bundle credential may be accomplished by using the optical reader (an active device) to obtain data from the optical indicia (a passive device) of the bundle credential. Such communication between components is only one example of a one-way communication system.

Another example of a one-way communication between components may be found in, e.g., RFID technology. For example, a patient zone controller may include a communication device in the form of an RF device capable of generating an RF field (one form of transmitting data) and receiving data from RFID tags activated by the RF field. One or more other components in the system that includes the patient zone controller, such as a bundle credential and/or health care worker credential, may include an RFID tag that, in the presence of the RF field, is capable of communicating data stored on the RFID tag. In such a system, the RFID tag, for the purposes of the systems and methods described herein, is also deemed to include a communication device, i.e., a device that can both receive data (the activating RF signal) and transmit data (the data that is transmitted to an RF receiver on the patient zone controller). Although the communication device of the RFID tag itself is not active, i.e., it is not activated in the absence of an RF field, it is active for the purposes of the systems and methods described herein because it can transmit and receive data in the presence of an activating RF field.

In still other embodiments of the systems and methods described herein, two components may include communication devices capable of both transmitting data and receiving data. For example, in some systems, the patient zone controller and the health care worker credential may both include a two-way communication device capable of both transmitting data and receiving data while the bundle credential includes only the ability to provide data to the patient zone controller and/or health care worker credential. In other systems, the patient zone controller and the bundle credential may include two-way communication devices, while the health care worker credential includes only the ability to provide data to the patient zone controller and/or bundle credential.

Another communication technology that may be incorporated into the systems described herein may include the dual mode communication schemes commonly used in the “passive keyless entry” systems employed in connection with automobiles and other vehicles. The patient zone controllers, bundle credentials and/or other system components may, in various embodiments, be equipped with dual mode communication devices.

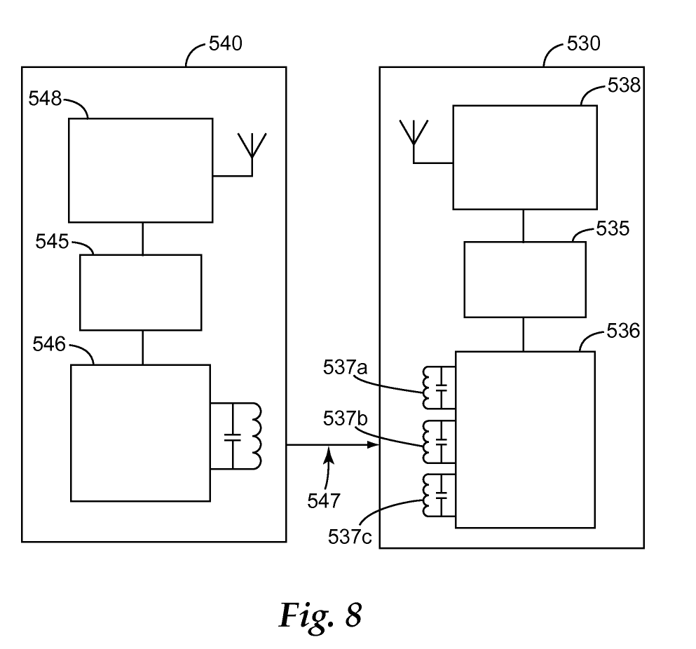

Referring to, e.g., FIG. 8, component such as, e.g., a registration apparatus 540 (which could be incorporated into a patient zone controller and/or a health care worker credential as discussed herein) is equipped with a dual mode communication system that includes a controller 545 and a low frequency (LF) transmitter 546 along with data communication device 548. The system may also include a bundle credential 530 that is equipped with a dual mode communication system that includes a controller 535 and a low frequency (LF) receiver 536 and a data transceiver 538.

The LF transmitter 546 of the registration apparatus 540 preferably emits a low frequency signal 547 (e.g., 125 kHz) periodically and/or continuously that can be used to activate or “wake-up” the data transceiver 538 in a bundle credential 530 that detects the LF signal. In those embodiments in which the registration apparatus 540 is incorporated into the patient zone controller, the LF transmitter 546 can be used to define the patient zone around the patient zone controller based on the strength of the LF signal 547 emitted by the LF transmitter 546. In such an embodiment a bundle credential 530 detecting the LF signal 547 at a selected signal strength level can then be considered as having entered the patient zone defined by the LF signal 547 emitted by the LF transmitter 546, and that entry results in activation of the data transceiver 538 of the bundle credential 530.

Activation of the data transceiver 538 in the bundle credential 530 may be accomplished by, e.g., reception of the LF signal 547 emitted by the LF transmitter 546 by the LF receiver 536 of the bundle credential 530. A LF wireless channel is used to accomplish activation of the data transceiver 538 in the bundle credential 530 when the bundle credential 530 receives that LF signal 547 in the patient zone. When activated, the data transceiver 538 of the bundle credential 530 preferably communicates by emitting and receiving signals in, e.g., the UHF (ultra high frequency) band, e.g., at 433 MHz. Communicating data in the UHF band can significantly reduce the time required to send and receive data between the communicating devices. That reduction in time required for data communication when using the UHF band can increase system response time and battery life. The higher data transmission rates may also allow for the use of encryption for a more secure communication link.

As discussed above, after the bundle credential 530 “wakes-up” in response to receiving the LF signal 547 from the LF transmitter 546, the bundle credential 530 may preferably transmit its bundle data to the registration apparatus 540 (or any other device with an appropriate communication device) for registration using the data transceiver 538. By essentially operating in a low-power consumption mode in which the data transceiver 538 is not powered up, additional battery life savings may also be achieved.

Another potential advantage of using LF wavelength signals to activate the bundle credential 530 is that the longer wavelengths used in the LF signal (e.g., 125 kHz) are not as attenuated by metal or humans as are shorter wavelength signals (which, as discussed herein, may be useful when transmitting data). As a result, detection of the LF signal by the LF receiver 536 of the bundle credential 530 is not adversely affected by the location of the bundle credential on, e.g., a package, bundle, etc. In other words, the bundle credential 530 may be out of the line of sight of the LF transmitter 546 of the registration apparatus 540, but the LF signal emitted by the LF transmitter 546 may, nonetheless, still be detected by the LF receiver 536 of the bundle credential 530.

Furthermore, the ability to detect the LF signal 547 emitted by the LF transmitter 546 may also allow for accurate determination of the proximity between the bundle credential 530 and the registration apparatus 540 based on signal strength measurements. As a result, the strength of the LF signal 547 may, in some embodiments, be used to define the patient zone as discussed herein based on detected signal strength for the LF signal.

In some embodiments, the LF receiver 536 of the bundle credential 530 may include two or more antennas, with the different antennas mounted orthogonally relative to each other to improve the ability of the LF receiver 536 to receive LF signals in a variety of different orientations. If the LF receiver 536 includes three different antennas 537a-537c as depicted in FIG. 8 and the three different antennas are oriented orthogonally to each other (as in, e.g., an x-y-z coordinate system), then the ability of the LF receiver to receive LF signals 547 from the LF transmitter 546 can be improved regardless of the orientation of the bundle credential 530.

Although the embodiments of system described herein in connection with FIG. 8 include an LF transmitter and an LF receiver for proximity detection and activation of the system devices, with data communication being performed by separate communication devices, both of the devices could use LF communication devices if the speed of data transmission and/or power consumption were not as important.

Examples of some potentially useful dual-mode communication systems that may be used in connection with the systems described herein may be found in, e.g., U.S. Pat. No. 6,747,545 (Nowottnick et al.); US Patent Application Publication No. 2009/0256674 (Lee et al.); etc. Other systems that may be used to accomplish the same result may be described in, e.g., US Patent Application Publication No. 2008/0284564 (Leitch).

Although a variety of communication schemes have been described herein, many other variations exist and can be used in connection with the systems and methods described herein, i.e., the described communication schemes should not be considered as the only communication schemes for use with the systems and methods described herein.

In addition to the various aspects and embodiments of the systems and methods described herein, additional embodiments of the systems and methods may include the following embodiments:

In another aspect, some embodiments of a system for monitoring health care delivery as described herein include: a plurality of bundle credentials, wherein each bundle credential of the plurality of bundle credentials comprises bundle data associated with a selected health care bundle; registration apparatus configured to obtain the bundle data of the plurality of bundle credentials; a patient zone controller operably connected to the registration apparatus, wherein the patient zone controller is associated with only one selected patient and wherein the patient zone controller is configured to register the bundle data to the selected patient, wherein the system comprises data associating the patient zone controller with the selected patient, and wherein the patient zone controller optionally comprises on-board memory operably connected to a communication device, wherein at least some data transmitted and/or received by the communication device is stored by the on-board memory of the patient zone controller; and publication apparatus operably connected to the patient zone controller, the publication apparatus configured to communicate selected information to a person located proximate the selected patient, wherein the selected information is associated with the health care bundle that is registered to the selected patient.

In some embodiments of the systems described herein each bundle credential of the plurality of bundle credentials comprises optical indicia that comprises the bundle data, and wherein the registration apparatus comprises an optical reader configured to obtain the bundle data by reading the optical indicia and transfer the bundle data to the patient zone controller.

In some embodiments of the systems described herein each bundle credential of the plurality of bundle credentials comprises on-board memory operably connected to a communication device, wherein at least some data transmitted and/or received by the communication device is stored by the on-board memory of the bundle credential, and wherein the on-board memory contains the bundle data associated with the selected health care bundle; the patient zone controller defines a patient zone proximate the selected patient; and the registration apparatus is configured to transfer the bundle data from the plurality of bundle credentials to the patient zone controller when the plurality of bundle credentials enter the patient zone.

In some embodiments of the systems described herein a first bundle credential of the plurality of bundle credentials comprises optical indicia that comprises the bundle data and a second bundle credential of the plurality of bundle credentials comprises on-board memory operably connected to a communication device, wherein at least some data transmitted and/or received by the communication device is stored by the on-board memory of the second bundle credential, and wherein the on-board memory contains the bundle data associated with the selected health care bundle; the patient zone controller defines a patient zone proximate the selected patient; and the registration apparatus is configured to transfer the bundle data from the second bundle credential to the patient zone controller when the second bundle credential enters the patient zone, and wherein the registration apparatus further comprises an optical reader configured to obtain the bundle data of the first bundle credential by reading the optical indicia and transfer the bundle data to the patient zone controller.

In some embodiments of the systems described herein the registration apparatus is selected from the group consisting of a keyboard, mouse, a touch screen, microphone, touchpad and combinations thereof.

In some embodiments of the systems described herein the selected information communicated by the publication apparatus comprises at least one instruction for delivery of the health care bundle associated with the bundle credential.

In some embodiments of the systems described herein the publication apparatus comprises a display device and/or an audio device configured to communicate the selected information.

In some embodiments of the systems described herein the publication apparatus comprises a portable device.

In some embodiments, the systems described herein further comprise a health care worker credential and data associating the health care worker credential with a selected health care worker.

In some embodiments of the systems described herein that include a health care worker credential, each bundle credential of the plurality of bundle credentials comprises optical indicia that comprises the bundle data, and the health care worker credential is operably connected to an optical reader configured to obtain the bundle data by reading the optical indicia and store the bundle data in on-board memory on the health care worker credential, and the on-board memory is operably connected to a communication device, wherein at least some data transmitted and/or received by the communication device is stored in the on-board memory of the health care worker credential.

In some embodiments of the systems described herein that include a health care worker credential, each bundle credential of the plurality of bundle credentials comprises on-board memory operably connected to a communication device, wherein at least some data transmitted and/or received by the communication device is stored by the on-board memory of the bundle credential, and wherein the on-board memory contains the bundle data associated with the selected health care bundle; and the system is configured to transfer the bundle data from the bundle credential to the health care worker credential. In some embodiments of these systems, the patient zone controller is configured to define a patient zone proximate the selected patient, and further wherein the system is configured to transfer the bundle data from the health care worker credential to the patient zone controller when the health care worker credential enters the patient zone.

In some embodiments of the systems described herein that include a health care worker credential, the publication apparatus is configured to transmit the selected information to the health care worker credential, and wherein the health care worker credential comprises a communication device configured to communicate the selected information to the selected health care worker.

In some embodiments, the systems described herein further comprise a compliance data collector that is configured to collect compliance data that is indicative of delivery of the selected health care bundle.

In some embodiments of the systems described herein that include a compliance data collector, the compliance data collector is operably connected to the patient zone controller.

In some embodiments of the systems described herein that include a compliance data collector, the selected health care bundle comprises one or more components that comprise optical indicia, and wherein the compliance data collector comprises an optical reader configured to read the optical indicia on the one or more components.

In some embodiments of the systems described herein that include a compliance data collector, the compliance data collector comprises an input device selected from the group consisting of a keyboard, mouse, a touch screen, microphone, touchpad and combinations thereof.

In some embodiments of the systems described herein that include a compliance data collector, the compliance data collector and the publication apparatus are embodied in a common device. In some embodiments, the common device comprises a visual display device.

In another aspect, some embodiments of a system for monitoring health care delivery, the system comprising a plurality of bundle credentials, wherein each bundle credential of the plurality of bundle credentials comprises bundle data associated with a selected health care bundle; a health care worker credential that comprises on-board memory operably connected to a communication device, wherein at least some data transmitted and/or received by the communication device is stored by the on-board memory; data associating the health care worker credential with a selected health care worker in the on-board memory; registration apparatus configured to obtain the bundle data of the plurality of bundle credentials and transfer the bundle data to the on-board memory; publication apparatus configured to communicate selected information to a person located proximate the health care worker credential. The system further includes a patient zone controller operably connected to the health care worker credential, wherein the patient zone controller is associated with only one selected patient and wherein the patient zone controller is configured to register bundle data received from the health care worker credential to the selected patient, wherein the system comprises data associating the patient zone controller with the selected patient, and wherein the patient zone controller optionally comprises on-board memory operably connected to a communication device, wherein at least some data transmitted and/or received by the communication device is stored by the on-board memory of the patient zone controller.

In some embodiments of the systems described herein each bundle credential of the plurality of bundle credentials comprises optical indicia that comprises the bundle data, and wherein the registration apparatus comprises an optical reader configured to obtain the bundle data by reading the optical indicia.

In some embodiments of the systems described herein each bundle credential of the plurality of bundle credentials comprises on-board memory operably connected to a communication device, wherein at least some data transmitted and/or received by the communication device is stored by the on-board memory of the bundle credential, and wherein the on-board memory contains the bundle data associated with the selected health care bundle; the patient zone controller defines a patient zone proximate the selected patient; and the health care worker credential is configured to transfer the bundle data from the plurality of bundle credentials to the patient zone controller when the health care worker credential enters the patient zone.

In some embodiments of the systems described herein the selected information communicated by the publication apparatus comprises at least one instruction for delivery of the health care bundle associated with the bundle credential.

In some embodiments of the systems described herein the publication apparatus comprises a display device and/or an audio device configured to communicate the selected information.

In some embodiments, a method of monitoring health care bundle delivery as described herein includes registering a health care bundle with a system for delivery to a selected patient; communicating selected information to a health care worker delivering the registered health care bundle to a patient, wherein the selected information is chosen based on the registered health care bundle; and optionally collecting compliance data that is indicative of delivery of the registered health care bundle to the patient, optionally determining if the health care worker is complying with a delivery protocol associated with the registered health care bundle; and optionally delivering an alert to the health care worker if it is determined that the health care worker is not complying with the delivery protocol.

In some embodiments of the methods described herein, the registering comprises obtaining bundle data associated with the health care bundle by scanning optical indicia on a bundle credential associated with the health care bundle.

In some embodiments of the methods described herein, the registering comprises obtaining the bundle data associated with the health care bundle using an RFID communication link.

In some embodiments of the methods described herein, the selected information comprises one or more instructions associated with delivery of the registered health care bundle.

In some embodiments of the methods described herein, the selected information is provided to the selected health care worker using a display device and/or an audible device.

In some embodiments of the methods described herein, collecting the compliance data comprises reading one or more optical indicia associated with the registered health care bundle.

In some embodiments of the methods described herein, collecting the compliance data comprises entering the compliance data into the system using an input device selected from the group consisting of a keyboard, mouse, touch screen, microphone, and touchpad.

In some embodiments, the methods described herein further comprise comparing the registered health care bundle to a prescribed health care bundle for the patient; and providing an alert if the registered health care bundle is not prescribed.

In some embodiments of the methods described herein, determining if the health care worker is complying with a delivery protocol associated with the registered health care bundle comprises detecting time between delivery of two different health care bundles.

In some embodiments of the methods described herein, determining if the health care worker is complying with a delivery protocol associated with the registered health care bundle comprises comparing a sequence of detected events in the compliance data with a predetermined sequence of events in the delivery protocol.

In some embodiments of the methods described herein, determining if the health care worker is complying with a delivery protocol associated with the registered health care bundle comprises comparing timing between detected events in the compliance data with a predetermined timing between events in the delivery protocol.

In some embodiments of the methods described herein, delivering an alert to the health care worker if it is determined that the health care worker is not complying with the delivery protocol comprises delivering one or more selective instructions for corrective action to the health care worker.

In another aspect, a method of monitoring health care bundle delivery as described herein includes detecting entry of a health care worker credential into a patient zone, wherein a selected patient is associated with the patient zone and wherein a selected health care worker is associated with the health care worker credential; detecting entry of a bundle credential into the patient zone, wherein the bundle credential is associated with a selected health care bundle; registering the health care bundle associated with the bundle credential with the selected patient associated with the patient zone; and providing selected information to the selected health care worker, wherein the selected information is selected based at least in part on the registered health care bundle.

In some embodiments of the methods described herein, the selected information comprises at least one instruction for using the registered health care bundle to provide health care for the selected patient.

In some embodiments of the methods described herein, the selected information is provided to the selected health care worker using a display device and/or an audible device.

In some embodiments of the methods described herein, the method further comprises collecting compliance data indicative of use of the registered health care bundle by the selected health care worker.

In some embodiments of the methods described herein that include collecting compliance data, the compliance data is entered into the patient zone controller.

In some embodiments of the methods described herein that include collecting compliance data, collecting the compliance data comprises reading one or more optical indicia associated with the health care bundle.

In some embodiments of the methods described herein that include collecting compliance data, the registered health care bundle comprises a plurality of components, wherein each component comprises an optical indicia, and wherein collecting the compliance data comprises reading the optical indicia on the plurality of components.

In some embodiments of the methods described herein that include collecting compliance data, collecting the compliance data comprises entering the compliance data using an input device selected from the group consisting of a keyboard, mouse, touch screen, microphone, and touchpad.

In some embodiments of the methods described herein, the method further comprises: comparing the registered health care bundle to a prescribed health care bundle for the selected patient associated with the patient zone; and providing an alert to the selected health care worker if the registered health care bundle is not prescribed.

In some embodiments of the methods described herein, the patient zone controller performs the entry detection of the health care worker credential, registers the health care bundle with the selected patient; and provides the selected information to the selected health care worker. In some embodiments, the patient zone controller performs the entry detection of the bundle credential. In some embodiments, entry detection of the bundle credential is performed by associating the bundle credential with the health care worker credential and detecting entry of the bundle credential upon detecting entry of the health care worker credential, wherein the bundle credential is associated with the health care worker credential before the health care worker credential is detected as entering the patient zone.

The complete disclosure of the patents, patent documents, and publications cited herein are incorporated by reference in their entirety as if each were individually incorporated.

Exemplary embodiments of hygiene monitoring systems and methods have been discussed and reference has been made to possible variations. These and other variations and modifications will be apparent to those skilled in the art without departing from the scope of the invention, and it should be understood that the invention is not limited to the illustrative embodiments set forth herein. Accordingly, the invention is to be limited only by the claims provided below and equivalents thereof.

1. A system for monitoring health care delivery, the system comprising:
a plurality of bundle credentials, wherein each bundle credential of the plurality of bundle credentials comprises bundle data associated with a selected health care bundle;
registration apparatus configured to obtain the bundle data of the plurality of bundle credentials;
a patient zone controller operably connected to the registration apparatus, wherein the patient zone controller is associated with only one selected patient and wherein the patient zone controller is configured to register the bundle data to the selected patient; and
publication apparatus operably connected to the patient zone controller, the publication apparatus configured to communicate selected information to a person located proximate the selected patient, wherein the selected information is associated with the health care bundle that is registered to the selected patient.

2. A system according to claim 1, wherein a bundle credential of the plurality of bundle credentials comprises optical indicia that comprises the bundle data, and wherein the registration apparatus comprises an optical reader configured to obtain the bundle data by reading the optical indicia and transfer the bundle data to the patient zone controller.

3. A system according to claim 1, wherein a bundle credential of the plurality of bundle credentials comprises on-board memory operably connected to a communication device, wherein at least some data transmitted and/or received by the communication device is stored by the on-board memory of the bundle credential, and wherein the on-board memory contains the bundle data associated with the selected health care bundle;
wherein the patient zone controller defines a patient zone proximate the selected patient;
and wherein the registration apparatus is configured to transfer the bundle data from the bundle credential to the patient zone controller when the bundle credential enters the patient zone.

4. A system according to claim 1, wherein the system further comprises a bundle dispenser that comprises a carrier and a communication device, wherein the carrier comprises a plurality of health care bundles, and wherein the communication device is configured to receive and/or transmit bundle data associated with the plurality of health care bundles.

5. A system according to claim 4, wherein the bundle dispenser is associated with only one selected patient.

6. A system according to claim 4, wherein the bundle dispenser is configured to function as the bundle credentials for the plurality of health care bundles contained in the carrier.

7. A system according to claim 4, wherein one bundle credential of the plurality of bundle credentials is associated with each health care bundle of the plurality of health care bundles in the carrier.

8. A system according to claim 1, wherein the selected information published by the publication apparatus comprises at least one instruction for delivery of the health care bundle associated with the bundle credential.

9. A system according to claim 1, wherein the system further comprises a health care worker credential and data associating the health care worker credential with a selected health care worker.

10. A system according to claim 9, wherein a bundle credential of the plurality of bundle credentials comprises optical indicia that comprises the bundle data, and wherein the health care worker credential is operably connected to an optical reader configured to obtain the bundle data by reading the optical indicia and store the bundle data in on-board memory on the health care worker credential.

11. A system according to claim 9, wherein a bundle credential of the plurality of bundle credentials comprises on-board memory operably connected to a communication device, wherein at least some data transmitted and/or received by the communication device is stored by the on-board memory of the bundle credential, and wherein the on-board memory contains the bundle data associated with the selected health care bundle;
and wherein the system is configured to transfer the bundle data from the bundle credential to the health care worker credential using the communication device of the bundle credential.

12. A system according to claim 9, wherein the patient zone controller is configured to define a patient zone proximate the selected patient, and further wherein the system is configured to transfer the bundle data from the health care worker credential to the patient zone controller when the health care worker credential enters the patient zone.

13. A system according to claim 9, wherein the publication apparatus is configured to transmit the selected information to the health care worker credential, and wherein the health care worker credential comprises a communication device configured to communicate the selected information to the selected health care worker.

14. A system according to claim 1, wherein the system further comprises a compliance data collector that is configured to collect compliance data that is indicative of delivery of the selected health care bundle.

15. A system for monitoring health care delivery, the system comprising:
a plurality of bundle credentials, wherein each bundle credential of the plurality of bundle credentials comprises bundle data associated with a selected health care bundle;
a health care worker credential that comprises:
on-board memory operably connected to a communication device, wherein at least some data transmitted and/or received by the communication device is stored by the on-board memory;
data associating the health care worker credential with a selected health care worker in the on-board memory;
registration apparatus configured to obtain the bundle data of the plurality of bundle credentials and transfer the bundle data to the on-board memory;
publication apparatus configured to communicate selected information to a person located proximate the health care worker credential; and
a patient zone controller operably connected to the health care worker credential, wherein the patient zone controller is associated with only one selected patient and wherein the patient zone controller is configured to register bundle data received from the health care worker credential to the selected patient.

16. A system according to claim 15, wherein a bundle credential of the plurality of bundle credentials comprises optical indicia that comprises the bundle data, and wherein the registration apparatus comprises an optical reader configured to obtain the bundle data by reading the optical indicia.

17. A system according to claim 15, wherein a bundle credential of the plurality of bundle credentials comprises on-board memory operably connected to a communication device, wherein at least some data transmitted and/or received by the communication device is stored by the on-board memory of the bundle credential, and wherein the on-board memory contains the bundle data associated with the selected health care bundle;
wherein the patient zone controller defines a patient zone proximate the selected patient;
and wherein the health care worker credential is configured to transfer the bundle data to the patient zone controller when the health care worker credential enters the patient zone.

18. A system according to claim 15, wherein the selected information communicated by the publication apparatus comprises at least one instruction for delivery of the health care bundle associated with the bundle credential.

19. A system according to claim 15, wherein the publication apparatus comprises a visual display device and/or an audio device configured to communicate the selected information.

20. A method of monitoring health care bundle use, the method comprising:
associating a patient zone controller with only one selected patient;
registering a selected health care bundle for delivery to the selected patient, wherein the registering comprises obtaining bundle data from a bundle credential associated with the selected health care bundle;
publishing selected information to a health care worker delivering the registered health care bundle to a patient, wherein the selected information is chosen based on the registered health care bundle; and
collecting compliance data that is indicative of delivery of the registered health care bundle to the patient.

21. A method according to claim 20, wherein the method further comprises determining if the health care worker is complying with a delivery protocol associated with the selected health care bundle, and delivering an alert to the health care worker if it is determined that the health care worker is not complying with the delivery protocol.

22. A method according to claim 20, wherein the registering comprises obtaining the bundle data associated with the selected health care bundle by scanning optical indicia on the bundle credential associated with the selected health care bundle.

23. A method according to claim 20, wherein the selected information comprises one or more instructions associated with delivery of the registered health care bundle.

24. A method according to claim 20, wherein collecting the compliance data comprises reading one or more optical indicia associated with the registered health care bundle.

25. A method of monitoring health care bundle use, the method comprising:
detecting entry of a bundle credential into a patient zone, wherein a selected patient is associated with the patient zone and wherein the bundle credential is associated with a selected health care bundle;
registering the selected health care bundle associated with the bundle credential with the selected patient associated with the patient zone; and
publishing selected information proximate the patient zone, wherein the selected information is selected based at least in part on the selected health care bundle.

26. A method according to claim 25, the method further comprising detecting entry of a health care worker credential into a patient zone, wherein a selected health care worker is associated with the health care worker credential.

27. A method according to claim 25, wherein the selected information comprises at least one instruction for using the selected health care bundle to provide health care for the selected patient.

28. A method according to claim 25, wherein the method further comprises collecting compliance data indicative of use of the registered health care bundle by the selected health care worker.

29. A method according to claim 25, wherein the method further comprises:
comparing the registered health care bundle to a prescribed health care bundle for the selected patient associated with the patient zone; and
providing an alert to the selected health care worker if the registered health care bundle is not prescribed.

30. A method according to claim 25, wherein the patient zone controller performs the entry detection of the health care worker credential, registers the health care bundle with the selected patient; and provides the selected information to the selected health care worker.

31. A method according to claim 30, wherein the patient zone controller performs the entry detection of the bundle credential.

32. A method according to claim 30, wherein entry detection of the bundle credential is performed by associating the bundle credential with the health care worker credential and detecting entry of the bundle credential upon detecting entry of the health care worker credential, wherein the bundle credential is associated with the health care worker credential before the health care worker credential is detected as entering the patient zone.
